(19) United States
(12) Patent Application Publication
(10) Pub. No.: US 2007/0130586 A1
(43) Pub. Date: Jun. 7, 2007

(54) Broadcast receiver and OAD download method of the same

(75) Inventor: Yu Jin Kim, Pohang-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/607,865

(22) Filed: Dec. 4, 2006

(30) Foreign Application Priority Data
Dec. 5, 2005 (KR) 10-2005-0117428

(51) Int. Cl. H04N 7/16; G06F 13/00; H04N 7/173; H04N 5/445; G06F 3/00

(52) U.S. Cl. 725/50; 725/132; 725/140; 725/152

(57) ABSTRACT

The invention relates to a broadcast method comprising a receiver for receiving a firmware or software, downloading and updating the firmware on the broadcast receiver, which comprises storing a final channel, selecting a over the air download channel automatically, operating a over the air download via the over the air download channel, and converting the over the air download channel to the final channel when the over the air download is completed.

### BACKGROUND OF THE INVENTION

1. Field of the Invention

The present invention relates to a broadcast receiver, and more specifically, to a digital broadcast method and apparatus for updating software on a broadcast receiver over the air, via the cable network system and satellite.

2. Background of the Invention

As it will be apparent from the following specification, the term “firmware” is used herein to describe functional operating software that is downloaded to a television receiver or other device and stored in nonvolatile memory. Until the downloaded “firmware” is changed, it resides in hardware (i.e., nonvolatile memory) just like conventional firmware.

In a typical television system, the firmware or necessary software such as graphical user interface are normally pre-installed in the broadcast receiver. The firmware or software pre-installed on the broadcast receiver is used to control a digital broadcast system via the user interface. Thus, firmware has to be updated as the digital broadcast system changes and develops, and the firmware also needs to be updated to enhance the digital broadcast system.

In the conventional art, in order to update the firmware for the broadcast receiver, a technician must either visit each television owner to update the firmware or a user must download the latest firmware from the internet to update the firmware. Such updating process would obviously be a troublesome and possibly expensive task for the broadcast receiver user.

### SUMMARY OF THE PRESENT INVENTION

An object of the present invention is to provide a broadcast receiving method and a broadcast receiver capable of receiving a broadcast signal and a firmware data, and the firmware is automatically downloaded and updated on a broadcast receiver.

Another object of the present invention is to provide a manual firmware update method operated by a user. The user can update firmware on a broadcast receiver via OSD. The operation of the OAD was not an easy task for those who do not know how to operate the OAD functions.

An OAD method according to the present invention comprises the steps of method comprising determining if a receiver is in stand-by mode, selecting an over the air download channel through which a data being transferred, for downloading software data if a receiver is determined to be in stand-by mode, and operating an over the air download via the over the air download channel. An OAD method according to the present invention is characterized by further comprising the step of storing the final channel information.

Further, An OAD method according to the present invention is characterized by further comprising a step of changing the OAD channel to the final channel after or when the OAD process is completed.

Furthermore, an OAD method according to the present invention is characterized by further comprising a step for perceiving an over the air download signal before the step for determining the stand-by mode. An OAD method according to the present invention is further characterized by further comprising a step for asking the user whether to update the over the air download data on a receiver manually or automatically after the over the air download signal is perceived. The OAD method according to the above-described invention further comprises a step for displaying an error message on a display device if the over the Air download is operated improperly.

The present invention is also characterized by comprising at least one tuner for changing in accordance with a control signal, at least one memory for storing an OAD data and a controller for controlling the determination whether a receiver is in stand-by mode, storing the final channel information in the memory, and downloading an OAD data in the memory.

It is effective that the user can easily update the firmware without changing the channel.

### BRIEF DESCRIPTION OF THE DRAWINGS

The foregoing and other objects, features, aspects and advantages of the present invention will become more apparent from the following detailed description of the present invention when taken in conjunction with the accompanying drawings.

FIG. 1 is a flowchart illustrating the steps of OAD process.

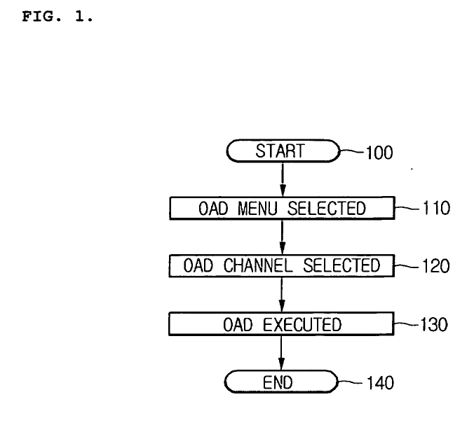

FIG. 2 is a flowchart illustrating the over the air download (OAD) method in accordance with the present invention.

FIG. 3 is a block diagram related to the description of a main portion related to an over the air download method and broadcast receiving apparatus according to the present invention.

FIG. 4 is a flow chart illustrating an OAD method for displaying an error message in accordance with FIG. 3.

FIG. 5 is a flow chart illustrating an OAD method such as a step of perception and updating process.

FIG. 6 is a block diagram related to the description of a portion related to an over the air download method and broadcast receiving apparatus according to the present invention.

### DETAILED DESCRIPTION OF THE INVENTION

The OAD (Over the Air Download) may comprise the method of updating the firmware by receiving the broadcast signal and extracting the updated software from the received broadcast signal.

It is effective that the user can easily update the firmware on a broadcast receiver.

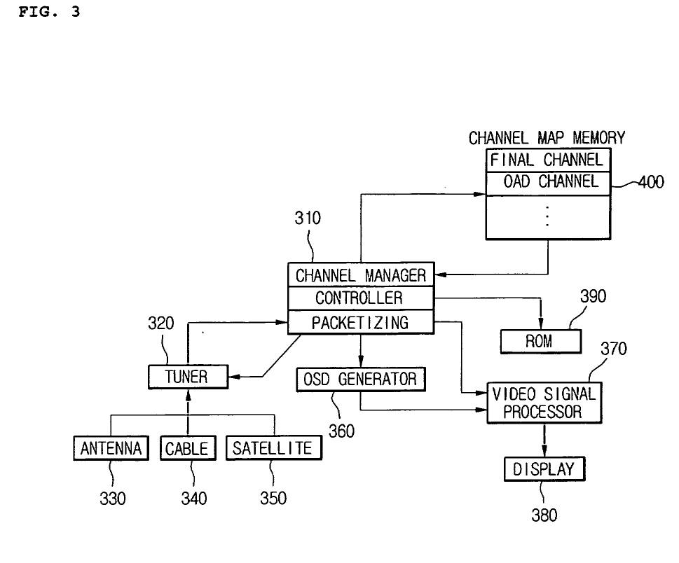

As shown in FIG. 3, a broadcast receiver is characterized by comprising a CPU 310, tuner 320, OSD generator 360, Firmware Rom 390, Video processor 370, Display 380 and Channel map memory 300.

CPU 310 is a channel manager for storing the final channel to a predetermined location of a channel map memory 300 when the broadcast receiver is in stand-by mode, and the OAD channel is tuned. The final channel represents the final channel that the user watched finally before turning off the television. Once, the OAD operation is completed, the final channel in the channel map memory 300 is re-tuned.

A stream received from a tuner 320 is packetized and stored in Rom 390. A stream data received from a tuner 320 is packetized and may be stored in a temporary memory. If the stream data is successfully downloaded, then the stream data stored in a temporary memory is transferred to Rom 390.

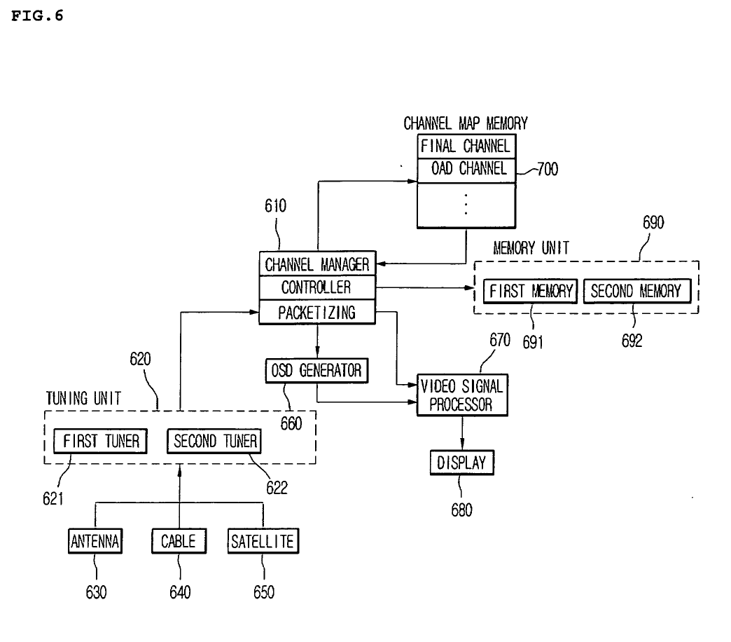

Referring to FIG. 6 of the present invention, a memory unit 690 may include a first memory 691 and a second memory 692. First memory 691 or second memory 692 can be either a volatile or a nonvolatile memory. Firmware or final channel information may be stored in the first memory 691 or the second memory 692.

A plurality of old-version firmware may be stored in a first memory 692 for a backup purpose when the user wants to use the old-version firmware again. A new-version firmware may be stored in a second memory 692. The second memory 692 may have substantially the same operation with the Rom 390. Moreover, several version of firmware may be stored in the first memory 692.

CPU 310 makes a tuner 320 to tune at a predetermined frequency, and the tuner 320 tunes, receives the broadcasted signal via such as antenna, cable and satellite, and sends as a stream format. CPU 310 packetizes the stream, and stores in Rom 390.

Tuner 320 tunes the frequency in order to receive the signal from the CPU 310 via a predetermined method such as an antenna, cable, or satellite.

On the other hand, OSD generator 360 sends an OSD signal to a video processor 370 in accordance with a CPU 310.

The OSD as described above is displayed on a display unit 380.

Rom 390 stores the OAD data downloaded via an OAD channel and this data is updated when the system is booted.

Channel map memory 300 stores the finally viewed channel, and sends the channel data to the CPU 310 in accordance with the Controller.

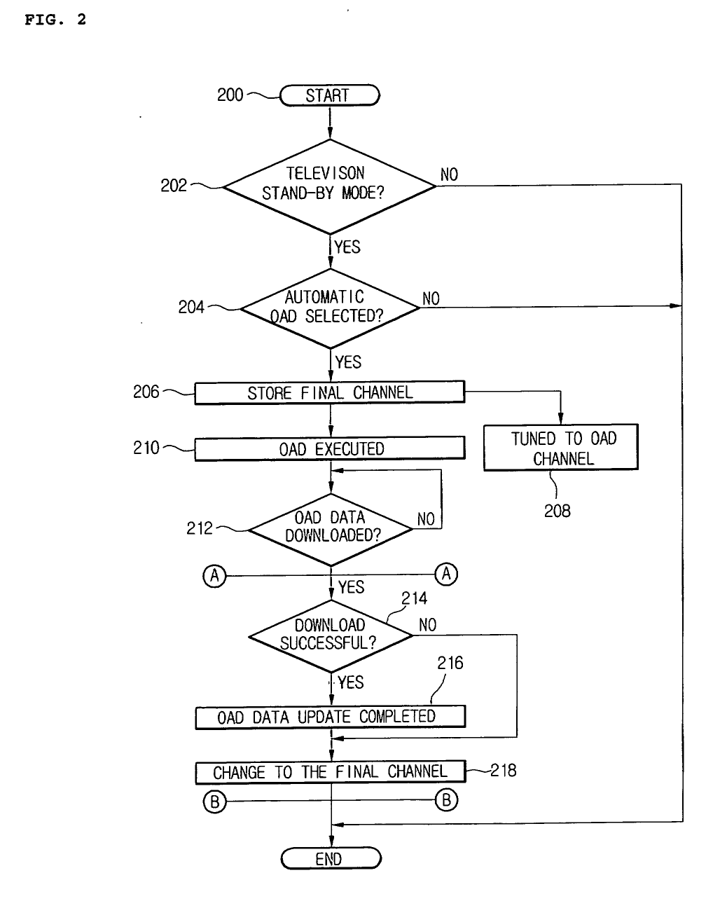

Referring to FIG. 2, the routine begins at step 200. At step 202, a determination is made whether the television is in stand-by mode.

The present invention is to provide an automatic OAD operation when the television is in stand-by mode. Even if the power of television is turned off, the power is still provided to the digital board in the television, and the circuit board is fully operated. When the television is not in stand-by mode, the step 224 is operated, and the whole process is terminated.

However, the present invention also provides a conventional method that a user can manually operate OAD via the OSD. Thus, it is noted that the present invention provides both manual and automatic OAD method in accordance with the user preference.

When the television is in stand-by mode, the step 204 commences. At step 204, a determination is made as to whether the automatic OAD function is selected. If the automatic OAD function is not selected, the routine proceeds to step 220 and the process ends. If the automatic OAD function is selected, the routine proceeds to step 206.

If a user manually executes the OAD, and step 202 and step 204 are ignored. When the TV power is turned on, and a user manually executes the automatic OAD, the routine begins at step 206.

At step 206, the final channel is a channel, which the user has watched finally, is stored in a channel map memory 300. Referring to FIG. 3, a channel manager 310 stores “the most recently viewed channel” data in a channel map memory 300. Once the OAD process is completed, the OAD channel is converted to the final channel. Since the broadcast receiving apparatus updates the firmware and converts the OAD channel to the final channel, it is very convenient for the user to do so.

The routine proceeds to step 208. At step 208, a channel is automatically tuned in accordance with a channel map memory 300 in FIG. 3. The television power is still in stand-by mode.

The routine proceeds to step 210. At step 210, the OAD is executed. In a prior art, an OAD is processed is embodied as below. First, software or firmware used in a digital broadcast receiver is formatted and encoded protocol for OC. The OAD software is multiplexed and sent with a broadcast stream and data stream for indexing programs. The stream being sent from the broadcasting station is sent to a broadcast receiver, and the receiver extracts the software from the broadcast signal, and updates the software in the receiver.

By this embodiment, even if the user is skilled to operate the OAD, the user is not able to watch the television program when the user is operating the OAD.

In its preferred embodiment, in order to update the firmware for the broadcast receiver, a new OAD signal is first perceived, an OAD channel is selected while a receiver is in stand-by mode, the OAD data is extracted from the signal, OAD is stored in a memory and the OAD data is updated on a receiver.

Referring to FIG. 3, an OAD software is inputted to a tuner 320 via antenna, cable network, and satellite. Tuner 320 processes a signal, and sends the signal to CPU 310. Controller 310 stores the digital signal processed OAD software in Rom 390.

Step 212 is required to delay a OAD process until the operation is completed, and once the OAD process is completed, the routine proceeds to step 214.

At step 214, it is determined whether a data is properly downloaded, and then the routine proceeds to step 216, and the OAD process is completed.

If a user chooses an automatic OAD update, the system is reset during the stand-by mode, and the downloaded software is installed in the system.

If a data is not installed properly, the routine proceeds to step 218 and terminates at step 220.

Furthermore, the embodiments of the present invention has been described with regard to a digital TV for updating the downloaded software over the air, the present invention is similar applicable to a receiver having a plurality of external ports.

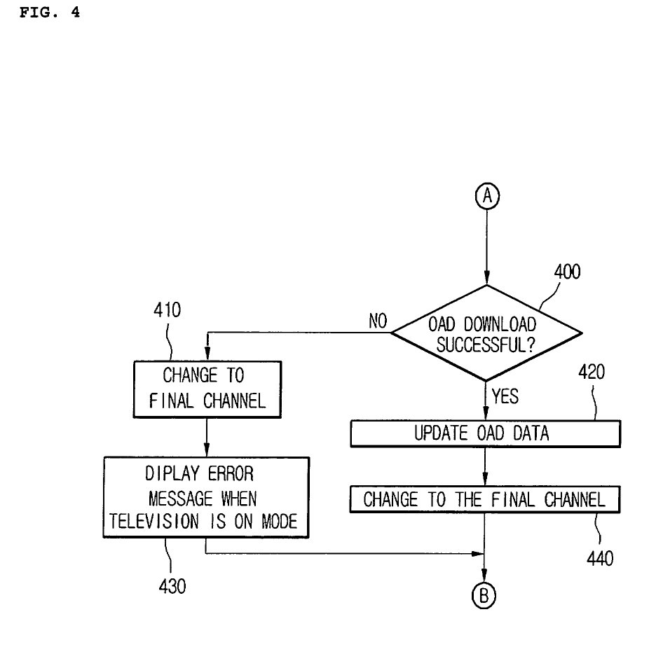

FIG. 4 is a flow chart illustrating an OAD method for displaying an error message when the OAD updating is operated improperly. FIG. 4 shows other embodiment of FIG. 3.

As shown in FIG. 4, Step A through B shows an alternative embodiment for displaying an error message if the OAD download is operated improperly. At step 400, it is determined whether a data is properly downloaded, and then the routine proceeds to step 420 to update OAD data if the data is properly downloaded. The routine proceeds to Step 440, and the OAD channel is changed to the final channel. On the other hand, if the data is not properly downloaded, the routine proceeds to step 410. At step 410, the OAD channel is changed to final channel and an error message is displayed when the user turns on the television as shown in Step 430.

Think and write effects by this embodiment as many as possible.

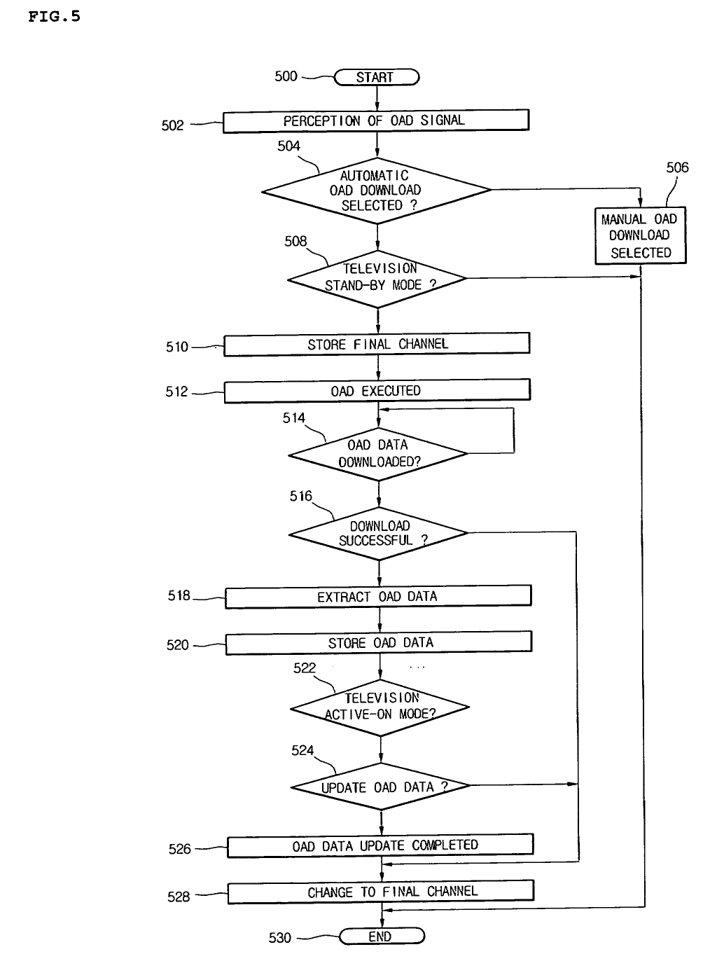

FIG. 5 is a flow chart illustrating an OAD method such as a step of perception and updating process.

In this embodiment is an alternative embodiment of the method according to this invention includes a step of perceiving OAD signal.

The routine begins at step 500, and OAD signal is perceived by a broadcast receiver at step 502.

At step 504, a determination is made as to whether the automatic OAD download is selected. If the automatic OAD download is selected, the routine proceeds to step 508 and if the automatic OAD download is not selected, and then the routine proceeds to step 506. The manual OAD download is selected at Step 506, and then the routine is terminated.

The manual download represents the selection of OAD download via OSD by the user.

At step 508, a determination is made as to whether the receiver is in stand-by mode. If the receiver is not in stand-by mode, then the routine is terminated. On the other hand, if the receiver is in stand-by mode, the routine proceeds to step 510. At step 510, final channel information is stored in Memory Unit 690.

The routine proceeds to step 512. At step 512, the OAD is executed. Step 514 ensures that the OAD download is fully completed, and once the OAD download is completed, the routine proceeds to step 516.

At step 516, a determination is made as to whether the OAD download is successful. If the OAD download is not successful, the routine proceeds to step 528. If the OAD download is successful, the routine proceeds to step 518.

At step 518, OAD data is extracted from the OAD signal. At step 520, OAD data is stored in either a first memory 691 or a second memory 692. The OAD data is not only limited to represent operating software and firmware, but also other necessary software.

The routine proceeds to Step 522. At step 522, a determination is made as to whether the television is in active-on mode. If the television is in active-on mode, another determination is made as to whether to update the OAD data at step 524.

At step 524, once the OAD process is completed, a user can make a decision whether the downloaded software should be installed. In this case, a user can update the software as the television power was turned on or a user can additionally update the software via the OSD menu. As described-above, a user decides whether the downloaded software should be updated, and commands updating process if the user decides to do so.

At step 526, OAD data update is completed, and the OAD channel is changed to the final channel at step 528. If the user decides not to update the OAD data on a receiver at step 524, the routine proceeds to step 528. At step 528, the OAD channel is changed to the final channel, and then the routine is terminated.

It is effective that the user may easily update the firmware without changing the television channel back and forth.

It will now be appreciated that the present invention provides a method and apparatus for updating a firmware of a broadcast receiver when the receiver is in stand-by mode.

Although the present invention has been described in connection with a preferred embodiment, it will be appreciated that man modifications and adaptations may be made thereto without departing from the spirit and scope of the invention as set forth in the following claims.

What is claimed is:

1. An over the air download method comprising:
determining if a receiver is in stand-by mode;
selecting an over the air download channel through which a data being transferred, for downloading software data if a receiver is determined to be in stand-by mode; and
operating an over the air download via the over the air download channel.

2. The over the air download method according to claim 1, further comprising:
storing a final channel information.

3. The over the air download method according to claim 2, further comprising:
changing the over the air download channel to the final channel after or when the over the air download is completed.

4. The over the air download method according to claim 1, further comprising a step for perceiving an over the air download signal before the step for determining the stand-by mode.

5. The over the air download method according to claim 1, further comprising a step for asking an user whether to update the over the air download data on a receiver manually or automatically, after the air download signal is perceived.

6. The over the air download method according to claim 1, further comprising:
displaying an error message on a display device if the over the Air download is operated improperly.

7. A broadcast receiver comprising:
at least one tuner for changing a channel in accordance with a control signal;
at least one memory for storing an over the air download data; and
a controller for controlling the determination whether a receiver is in stand-by mode, storing a final channel information in the memory, and downloading an over the air download data in the memory.

8. The broadcast receiver according to claim 7, wherein the memory includes a first memory for storing the downloaded data and a second memory installing the downloaded data.

9. The broadcast receiver according to claim 7, wherein the controller changes the over the air download channel to the final channel after or when the receiver is in stand-by mode.

10. The broadcast receiver according to claim 7, further comprising:
an on screen display generator for displaying information via an on screen display.

11. The broadcast receiver according to claim 7, wherein the controller sends a signal indicating that the over the air download is operated improperly to the on screen display generator.

12. The broadcast receiver according to claim 9, wherein the broadcast receiver comprises a first tuner for selecting channel to receiver a broadcast signal and a second tuner for receiving an OAD data.

13. A software updating method comprising:
perceiving an over the air download signal;
determining if a broadcast receiver is stand-by mode;
selecting an over the air download channel while a receiver is in stand-by mode;
receiving a signal including an over the air download data;
extracting the over the air download data from the signal;
storing the over the air download data in a memory; and
updating the over the air download data on a receiver.

14. The software updating method according to claim 13, wherein the over the air download is updated on a receiver selectively by a user.

15. The software updating method according to claim 12, wherein the over the air download data includes a firmware data.

16. The software updating method according to claim 15, wherein the firmware is updated on a receiver via an wired network or wireless network.

17. The software updating method according to claim 13, wherein the signal is a stream data.

18. The software updating method according to claim 13, wherein the stream data is packetized.

19. An over the air download method comprising:
selecting an over the air download channel and storing an final channel information;
operating an over the air download process via the over the air download channel; and
changing the over the air download channel to the final channel when the receiver turns active-on mode.

20. The over the air download method according to claim 19, further comprising:
displaying an message when the receiver turns active-on mode.

21. The over the air download method according to claim 19, wherein the message is an error message or updating message.

22. An over the air download method comprising:
perceiving an over the air download signal; and
operating an over the air download via the over the air download channel.

23. The over the air download method according to claim 22, further comprising:
determining whether to receive the over the air download data after the perceiving step.

24. The over the air download method according to claim 22, further comprising:
determining whether to install the over the air download data on the receiver after the operation step.

25. The over the air download method according to claim 22, further comprising:
displaying a download progress indicator on a display.
